(19) United States
(12) Patent Application Publication
(10) Pub. No.: US 2013/0210945 A1
(43) Pub. Date: Aug. 15, 2013

(54) CROSS-LINKED ELASTOMER COMPOSITION AND PRODUCT INCLUDING SUCH A COMPOSITION

(71) Applicants: Fabrice Picot, Tiffauges (FR); Démosthène Sakkas, Woluwe Saint Lambert (BE); Aline Grudet, Clisson (FR)

(72) Inventors: Fabrice Picot, Tiffauges (FR); Démosthène Sakkas, Woluwe Saint Lambert (BE); Aline Grudet, Clisson (FR)

(21) Appl. No.: 13/805,330

(22) PCT Filed: Jun. 20, 2011
(86) PCT No.: PCT/EP11/60250

§ 371 Date: Apr. 15, 2013

(30) Foreign Application Priority Data
Jun. 18, 2010 (FR) 1054860

(51) Int. Cl. C08L 53/02

(52) U.S. Cl. CPC C08L 53/02
USPC 521/89; 525/89; 521/95; 521/97; 521/94; 521/148

(57) ABSTRACT

The invention relates to a cross-linked elastomer composition including: an ethylene/alpha-olefin multiblock copolymer comprising polymerized ethylene and alpha-olefin units, an elastomer including a block copolymer having at least two, identical or different, aromatic blocks which are separated by at least one elastomer block, and a cross-linkable polymer, for example, a diene elastomer. The invention also relates to a product including the composition, and to the use of such a product as a seal.

The present invention relates to elastomeric compositions, and in particular compositions based on thermoplastic elastomers. Such compositions are used in particular in the sealant field in the building trade, for motor vehicle applications or for the manufacture of mass-produced products requiring a high compressive strength.

Seals intended for motor vehicle applications or applications in the building trade must have stable dimensions, offer a low compression set (DRC) and have sealing characteristics defined over a wide range of temperatures which can range up to 100° C. Moreover, such seals must be capable of noiseproofing, windproofing and waterproofing, while at the same time being resistant to ultraviolet (UV) radiation for a prolonged period of time. At the same time, the composition must keep its flexibility and elasticity properties required for this field of application.

Historically, seals were manufactured from mixtures based on polyvinyl chloride (PVC). However, such compositions contain, and release in the event of combustion, halogenated molecules, which has required a search for other compositions that can replace these halogenated compositions. Furthermore, it was also necessary to improve the physical properties of these compositions in order to broaden the range of application.

The alternatives proposed are mainly: rubbers, and in particular those based on ethylene propylene diene monomer (EPDM), thermoplastic elastomer vulcanizates (TPE-V) and styrene thermoplastic elastomers (TPE-S). However, these alternatives have one or more drawbacks for the present field of application, in particular a poor colorability, a poor surface appearance, odor problems, etc.

The invention aims to remedy these drawbacks.

The objective of the invention is to propose, according to a first aspect, an economical composition, preferably devoid of halogenated compounds, which makes it possible to obtain an improved compromise between a low compression set, a matt or satin external appearance and a stability to ultraviolet exposure.

This composition comprises:
a multiblock copolymer of ethylene and of alpha-olefin comprising polymerized units of ethylene and of alpha-olefin, for example between 5 and 50% by weight, preferably between 9 and 25% by weight,
an elastomer comprising a block copolymer having at least two aromatic blocks, which may be identical or different, separated by at least one elastomeric block, for example between 3 and 50% by weight, and
a cross-linkable polymer, for example a diene elastomer, for example between 3 and 50% by weight, preferably between 4 and 30% by weight.

The term “elastomeric block” is intended to mean a block of which the glass transition temperature T_{g} is below ambient temperature, and preferably is below 0° C. The glass transition temperature is measured, for example, by differential scanning calorimetry, according to standard ISO 11357-2.

The multiblock copolymer of ethylene and of alpha-olefin is defined in particular in patent applications WO 2006/101966 and WO 2006/101930. The copolymer is a polymer which is particularly resistant to ultraviolet radiation, and has a low compression set (DRC). It makes it possible in particular to limit the aging, due to ultraviolet radiation, of the composition, without requiring the addition of black pigments or of other additives which reduce certain properties of the product.

The term “cross-linkable polymer” is intended to mean a polymer of which the macromolecules can bond to one another by a chemical reaction, occurring during a polymerization, a polycondensation or a polyaddition, for example. The cross-linkable polymer makes it possible, in particular by introducing cross-linking points into the composition, to give the composition a matt or satin appearance, and makes it possible to reduce the compression set. It also enables better resistance of a composition optionally comprising a partially unsaturated elastomer, during prolonged exposure to ultraviolet radiation, in comparison with the non-cross-linked composition. The cross-linkable polymer may be identical to or different than the block copolymer having at least two aromatic blocks, which may be identical or different, separated by at least one elastomeric block.

Finally, the block copolymer having at least two aromatic blocks, which may be identical or different, separated by at least one elastomeric block allows the formation of nodules of the aromatic blocks within the composition, whereas the elastomeric blocks will associate with the cross-linkable polymer and/or with the multiblock copolymer of ethylene and of alpha-olefin. At ambient temperature, the nodules, which have a glass transition temperature above ambient temperature, are then in the glassy state and can therefore be likened to crosslinking nodes, thereby creating a physical pseudo-crosslinking in addition to the chemical crosslinking provided by the cross-linkable polymer. It should be noted that the physical crosslinking and chemical crosslinking can be due to the same polymer, for example when SBS is used. A composition having a low compression set, but also a better resistance to ultraviolet radiation, while at the same time remaining in particular extrudable by virtue of a controlled chemical crosslinking, is then obtained in comparison with the non-cross-linked composition. When the block copolymer is SEBS, the composition can comprise between 3 and 50% by weight of SEBS, preferably between 4 and 30%, and even more preferentially between 10 and 20% by weight. When the block copolymer is SBS, the composition can comprise between 3 and 50% by weight of SBS, preferably between 4 and 30%.

Preferentially, the cross-linkable polymer is a poly-butadiene or a styrene-butadiene-styrene (SBS) triblock copolymer. When the cross-linkable polymer is SBS, the composition can comprise between 3 and 50% by weight of SBS, preferably between 4 and 30%. When the cross-linkable polymer is a polybutadiene, the composition can comprise between 3 and 50% by weight of polybutadiene, preferably between 4 and 30%, and even more preferentially between 4% and 6% by weight.

According to one embodiment, the cross-linkable polymer is syndiotactic 1,2-polybutadiene.

The styrene-butadiene-styrene (SBS) triblock copolymer is a triblock copolymer of which the ends are styrene blocks and the central elastomeric block is a butadiene copolymer. SBS makes it possible to obtain a more pronounced matt aspect, while polybutadiene, and in particular syndiotactic 1,2-polybutadiene in a mixture with SBS, makes it possible to obtain a lower compression set, a better resistance to ultraviolet radiation and a matt or satin appearance.

The elastomeric block of the block copolymer having at least two aromatic blocks, which may be identical or different, separated by at least one elastomeric block, preferentially comprises at least ethylene units and butylene or propylene units. The elastomeric block is chosen so as to exhibit compatibility with the other polymers of the composition. However, the elastomeric block of the copolymer is not limited to these two examples. The elastomeric block may thus be chosen from C₂-C₈ olefin homopolymers or copolymers, or alternatively from ethylene/butylene/styrene or ethylene/propylene/styrene blocks.

The aromatic blocks of the block copolymer having at least two aromatic blocks, which may be identical or different, separated by at least one elastomeric block, preferentially comprise at least one styrene unit. The aromatic blocks are chosen, firstly, so as to be not very compatible with the elastomeric block and, secondly, so as to have a glass transition temperature above ambient temperature. The aromatic blocks will then form nodules in the composition. These nodules are, at ambient temperature, in the glassy state and create physical pseudo-crosslinking which confers on the final product its mechanical properties of elasticity and resistance.

Advantageously, the molar mass of the styrene units of the block copolymer having at least two aromatic blocks, which may be identical or different, separated by at least one elastomeric block, represents between 10 and 50%, and preferably between 10% and 30% of the total molar mass of the block copolymer. The percentage of styrene units is chosen such that the aromatic blocks are not very compatible with the elastomeric block. The aromatic blocks may also comprise nonaromatic units. However, the aromatic blocks will advantageously comprise at least 80 mol % of aromatic units. The aromatic block may comprise, for example, at least one, and preferably at least 50 mol % of, styrene unit(s), or else α-methylstyrene or vinyl-naphthalene unit(s).

Preferentially, the block copolymer having at least two aromatic blocks, which may be identical or different, separated by at least one elastomeric block, is a styrene-ethylene/butylene-styrene (SEBS) triblock copolymer or a styrene-butadiene-styrene (SBS) triblock copolymer.

SBS is a copolymer which has a low compression set, and also makes it possible to introduce an amount of oil into the composition, thereby making it possible to reduce the overall cost of the composition. SEBS is a triblock copolymer of which the ends are styrene blocks and the central elastomeric block is an ethylene/butylene random copolymer. SEBS is chosen more particularly for its higher resistance to ultraviolet radiation.

The multiblock copolymer of ethylene and of alpha-olefin has an average block index of from 0.1 to 0.3 and a molecular weight distribution index (or polydispersity index), M_{w}/Mₙ, greater than 1.3, preferably between 1.7 and 3.5. The average block index and the method for determining this index are in particular defined in patent application WO 2006/101966.

The multiblock copolymer of ethylene and of alpha-olefin has a density of less than 0.91 g/cm³, for example between 0.89 and 0.91 g/cm³. The multiblock copolymer can also have a melt flow index of from 0.1 to 0.3 g/10 min, or even from 1.2 to 2 g/10 min.

The alpha-olefin is chosen from propylene, 1-butene, 1-hexene, 1-octene, 4-methyl-1-pentene, norbornene, 1-decene, 1,5-hexadiene, or a combination of such compounds.

The multiblock copolymer of ethylene and of alpha-olefin has at least one melting point Tₘ, in degrees Celsius, and a density d, in grams per cubic centimeter, the numerical values of which satisfy the relationships:

Tₘ>−2002.9+4538.5(d)−2422.2(d)²,

preferably:

Tₘ>−6288.1+13141(d)−6720.3(d)²,

and better still:

Tₘ>858.91−1825.3(d)+1112.8(d)²

The multiblock copolymer may comprise one or more hard segments comprising at least 98% by weight of ethylene, and one or more soft segments comprising less than 95% by weight, preferably less than 50% by weight, of ethylene. Preferentially, the hard segments are present in an amount of from 5 to 85% by weight. The ethylene content in the block copolymer may be greater than 50 mol %.

The composition may also comprise reinforcing or inert fillers such as: calcium carbonate, clays, silica, talc, carbon black, titanium dioxide, plasticizers and oils of thermoplastic rubbers, processing agents, antioxidants, anti-ultraviolet agents, waxes and other stabilizers, pigments, gliding agents, lubricants, antistatics, scratch-resistance agents, physical or chemical blowing agents and other formulation adjuvants. It is also possible to add to the composition blowing agents of the azodicarbonamide, sulfohydrazide, bicarbonate or urea family or microcellular blowing agents containing pressurized gases or volatile liquids.

The composition according to the first aspect thus has flexibility and elasticity properties over a wide range of temperatures, has a matt or satin appearance and good colorability and does not pose any problem with odor. Furthermore, if the composition comprises polybutadiene, it exhibits an improved resistance to ultraviolet radiation.

These properties thus make the composition according to the first aspect particularly suitable for a wide choice of applications.

According to a second aspect, a product comprising a composition according to the first aspect is proposed. The product can in particular be manufactured by extrusion or injection-molding of the composition according to the first aspect.

The product may be an injection-molded or extruded product, for motor vehicle applications or for overmolding applications, for example grips, kitchen utensils, sports items, etc.

The product can comprise a composition comprising physical or chemical blowing agents as described previously, and can be an expanded product.

According to a third aspect of the invention, it is proposed to use a product according to the second aspect as a leaktight seal.

The leaktight seal can be used for the building trade (building), for a motor vehicle or for industrial application (household appliance such as refrigerator, washing machine).

Presently considered, as a preferred embodiment of a product, in particular a leaktight seal, is a composition C1 comprising:
21.8% by weight of multiblock copolymer of ethylene and of alpha-olefin (Infuse D9000 from Dow),
5.9% by weight of polypropylene homopolymer,
2.9% by weight of medium-density polyethylene,
10.6% by weight of SBS (high-molecular-weight, non-oil-extended radial SBS containing 30% of styrene),
26% by weight of paraffin oil (highly refined white paraffin oil),
32.3% by weight of 5 μm chalk (Durcal 5 (Omya) or Craie DRB 20 (Imerys Minéraux)),
0.35% by weight of a protection system (Irganox 1076 FD or Chimassorb 944 FDL or Tinuvin 327 from Ciba Spécialités Chimiques SA (Additifs), or Irgafos 16 from BASF),
0.09% by weight of a peroxide (α,α′-bis(t-butylperoxy)-diisopropylbenzene), and
0.06% by weight of coagent triallyl cyanurate (TAC): TAC DL70 from Lehvoss).

The composition C1 therefore comprises 21.8% by weight of a multiblock copolymer of ethylene and of alpha-olefin and 10.6% by weight of a cross-linkable polymer having at least two aromatic blocks, which may be identical or different, separated by at least one elastomeric block. The SBS therefore acts both as a crosslinking agent (by virtue of the double bonds) and as a particular elastomer capable of forming nodules by virtue of the styrene blocks.

The composition can be prepared in the form of granules or else directly during manufacture of an injection-molded or extruded product such as a leaktight seal. Thus, when it is prepared in the form of granules, the composition C1 can be prepared by dry mixing, at ambient temperature, of its various solid ingredients, and then by extrusion.

The composition C1 has the following properties:
a hardness (measured according to standard ISO 868) of 60 Shore A,
a compression set (measured according to standard ISO 815, i.e. for 22 hours, at 70° C.) of 41%, and
a matt appearance.

The composition C1 thus makes it possible to obtain a product which has staying power and resistance properties, suitable for use in the building trade or in the motor vehicle industry. In particular, the composition has a matt appearance, by virtue especially of the SBS used.

A second embodiment of a product, in particular a leaktight seal, is considered, in which the composition C2 comprises:
13.6% by weight of multiblock copolymer of ethylene and of alpha-olefin (Infuse D9000 from Dow),
11.3% by weight of polypropylene homopolymer (100-GB006 (Ineos) or PP 571P (Sabic) or PPH3060 (Total)),
4.2% by weight of medium-density polyethylene (Lupolen 3721C from LydonDellBasell),
13.6% by weight of SEBS (Kraton G6151 ES from Kraton Polymer),
4.7% by weight of 1,2-polybutadiene (RB830 from JSR Corporation),
37% by weight of paraffin oil (Primol 352 from Esso),
14.8% by weight of 5 μm chalk (Durcal 5 (Omya) or Craie DRB 20 (Imerys Minéraux)),
0.72% by weight of a protection system (Irganox 1076 FD or Chimassorb 944 FDL or Tinuvin 327 from Ciba Spécialités Chimiques SA (Additifs), or Irgafos 16 from BASF),
0.05% by weight of a peroxide (Luperox F40 from Safic Alcan), and
0.03% by weight of an agent TAC (coagent triallyl-cyanurate (TAC): TAC FL70 from Lehvoss).

The composition C2 therefore comprises 13.6% by weight of a multiblock copolymer of ethylene and of alpha-olefin, 13.6% by weight of a block copolymer having at least two aromatic blocks, which may be identical or different, separated by at least one elastomeric block, and 4.7% by weight of a polybutadiene acting as a crosslinking agent.

The composition can be prepared in the form of granules or else directly during the manufacture of an injection-molded or extruded product such as a leaktight seal. Thus, when it is prepared in the form of granules, the composition C2 can be prepared by dry mixing, at ambient temperature, of its various solid ingredients and then by extrusion.

The composition C2 has the following properties:
a hardness (measured according to standard ISO 868 of 60 Shore A,
a compression set (measured according to standard ISO 815, i.e. for 22 hours, at 70° C.) of 36%,
a satin appearance,
a longer resistance to ultraviolet aging.

The composition C2 thus makes it possible to obtain a product which has staying power and resistance properties, suitable for its use in the building trade or in the motor vehicle industry. Moreover, the composition does not have a shiny appearance, but a satin appearance, owing to the blend of SEBS with the cross-linkable polymer RB830 which results in a less pronounced matt appearance, but in a greater resistance to ultraviolet radiation. Furthermore, it is also possible to color the composition, in order to obtain a colored final product. In particular, the high resistance to ultraviolet radiation makes it possible to color the product with light shades, although the latter generally accelerate the aging of the product.

A third embodiment of a product, in particular a leaktight seal, is considered, in which the composition C3 comprises:
14% by weight of multiblock copolymer of ethylene and of alpha-olefin (Infuse D9000 from Dow),
13% by weight of polypropylene homopolymer (100-GB0006 (Ineos) or PP 571P (Sabic) or PPH3060 (Total)),
3% by weight of medium-density polyethylene (Lupolen 3721C from LyonDellBasell),
5.9% by weight of 1,2-polybutadiene (RB830 from JSR Corporation),
12.5% by weight of SEBS (Kraton G6151 ES from Kraton Polymer),
36% by weight of paraffin oil (Primol 352 from Esso),
14.8% by weight of 5 μm chalk (Durcal 5 (Omya) or Craie DRB 20 (Imerys Minéraux)),
0.62% by weight of a protection system (Irganox 1076 FD or Chimassorb 944 FDL or Tinuvin 327 from Ciba Spécialités Chimiques SA (Additifs), or Irgafos 16 from BASF),
0.12% by weight of a peroxide (Luperox F40 from Safic Alcan), and
0.06% by weight of an agent TAC (coagent triallyl cyanurate (TAC): TAC DL70 from Lehvoss).

The composition C3 therefore comprises 14% by weight of a multiblock copolymer of ethylene and of alpha-olefin, 12.5% by weight of a cross-linkable polymer having at least two aromatic blocks, which may be identical or different, separated by at least one elastomeric block, and 5.9% by weight of a polybutadiene acting as a crosslinking agent.

The composition can be prepared in the form of granules or else directly during the manufacture of an injection-molded or extruded product such as a leaktight seal. Thus, when it is prepared in the form of granules, the composition C3 can be prepared by dry mixing, at ambient temperature, of its various solid ingredients and then by extrusion.

The composition C3 has the following properties:
a hardness (measured according to standard ISO 868) of 65 Shore A,
a compression set (measured according to standard ISO 815, i.e. for 22 hours, at 70° C.) of 36%, and
a satin appearance,
a longer resistance to ultraviolet aging.

The composition C3 thus makes it possible to obtain a product which has staying power and resistance properties, suitable for its use in the building trade or in the motor vehicle industry. Moreover, the composition does not have a shiny appearance, but a satin appearance, owing to the blend of SEBS with the cross-linkable polymer RB830, which results in a less pronounced matt appearance, but in a greater resistance to ultraviolet radiation.

A fourth embodiment of a product, in particular a leaktight seal, is considered, in which the composition C4 comprises:
13% by weight of multiblock copolymer of ethylene and of alpha-olefin (Infuse D9000 from Dow),
14.6% by weight of polypropylene homopolymer (100-GB006 (Ineos) or PP 571P (Sabic) or PPH3060 (Total)),
4% by weight of medium-density polyethylene (Lupolen 3721C from LyonDellBasell),
4.7% by weight of 1,2-polybutadiene (RB830 from JSR Corporation),
13% by weight of SEBS (Kraton G6151 ES from Kraton Polymer),
35% by weight of paraffin oil (Primol 352 from Esso),
14.3% by weight of 5 μm chalk (Durcal 5 (Omya) or Craie DRB 20 (Imerys Minéraux)),
1.22% by weight of a protection system (Irganox 1076 FD or Chimassorb 944 FDL or Tinuvin 327 from Ciba Spécialités Chimiques SA (Additifs), or Irgafos 16 from BASF),
0.12% by weight of a peroxide (Luperox F40 from Safic Alcan), and
0.06% by weight of an agent TAC (coagent triallyl cyanurate (TAC): TAC DL70 from Lehvoss).

The composition C4 therefore comprises 13% by weight of a multiblock copolymer of ethylene and of alpha-olefin, 13% by weight of a cross-linkable polymer having at least two aromatic blocks, which may be identical or different, separated by at least one elastomeric block, and 4.7% by weight of a polybutadiene acting as a crosslinking agent.

The composition can be prepared in the form of granules or else directly during the manufacture of an injection-molded or extruded product such as a leaktight seal. Thus, when it is prepared in the form of granules, the composition C4 can be prepared by dry mixing, at ambient temperature, of its various solid ingredients and then by extrusion.

The composition C4 has the following properties:
a hardness (measured according to standard ISO 868) of 70 Shore A,
a compression set (measured according to standard ISO 815, i.e. for 22 hours, at 70° C.) of 40%, and
a satin appearance,
a longer resistance to ultraviolet aging.

The composition C4 thus makes it possible to obtain a product which has staying power and resistance properties, suitable for its use in the building trade or in the motor vehicle industry. Moreover, the composition does not have a shiny appearance, but a satin appearance, owing to the blend of SEBS with the cross-linkable polymer RB830, which results in a less pronounced matt appearance, but in greater resistance to ultraviolet radiation.

1. A crosslinked elastomeric composition comprising:
a multiblock copolymer of ethylene and of alpha-olefin comprising polymerized units of ethylene and of alpha-olefin,
an elastomer comprising a block copolymer having at least two aromatic blocks, which may be identical or different, separated by at least one elastomeric block, and
a cross-linkable polymer.

2. The composition as claimed in claim 1, in which the cross-linkable polymer is a polybutadiene, for example syndiotactic 1,2-polybutadiene, or a styrene-butadiene-styrene (SEBS) triblock copolymer.

3. The composition as claimed in claim 1, in which the block copolymer is a styrene-ethylene/butylene-styrene (SEBS) triblock copolymer or a styrene-butadiene-styrene (SBS) triblock copolymer.

4. The composition as claimed in claim 1, in which the multiblock copolymer of ethylene and of alpha-olefin has an average block index of from 0.1 to 0.3 and a molecular weight distribution index, M_{w}/Mₙ, greater than 1.3.

5. The composition as claimed in claim 1, in which the multiblock copolymer of ethylene and of alpha-olefin has a density of less than 0.91 g/cm³.

6. The composition as claimed in claim 1, in which the alpha-olefin represents propylene, 1-butene, 1-hexene, 1-octene, 4-methyl-1-pentene, norbornene, 1-decene, 1,5-hexadiene, or a combination of such compounds.

7. The composition as claimed in claim 1, in which the multiblock copolymer of ethylene and of alpha-olefin has at least one melting point Tₘ, in degrees Celsius, and a volume d, in grams per cm³, in which the numerical values of these variables satisfy the relationships:
Tₘ>−2002.9+4538.5(d)−2422.2(d)²,
preferably:
Tₘ>−6288.1+13141(d)−6720.3(d)²,
and better still:
Tₘ>858.91−1825.3(d)+1112.8(d)².

8. The composition as claimed in claim 1, comprising one or more physical or chemical blowing agents, in particular blowing agents of the azodicarbonamide, sulfohydrazide, bicarbonate or urea family or microcellular blowing agents containing pressurized gases or volatile liquids.

9. A product, in particular an injection-molded or extruded product, comprising a composition as claimed in claim 1.

10. The product as claimed in claim 9, comprising a composition as claimed in claim 8 and in which the product is expanded.

11. The use of a product as claimed in claim 9, as a leaktight seal.
